(19) United States
(12) Patent Application Publication
(10) Pub. No.: US 2008/0012313 A1
(43) Pub. Date: Jan. 17, 2008

(54) Compact connector

(76) Inventor: Antonio Carlos Reinholtz, Vinhedo - SP (BR)

Correspondence Address: TRASK BRITT, P.O. BOX 2550, SALT LAKE CITY, UT, 84110, US

(21) Appl. No.: 11/643,035

(22) Filed: Dec. 19, 2006

(30) Foreign Application Priority Data
Dec. 19, 2005 (BR) P10505733-7

(51) Int. Cl. F16L 37/00

(52) U.S. Cl. 285/308

(57) ABSTRACT

The instant specification refers to a connector structure used in vehicle fluid lines, such as vehicle fuel lines, used between a fuel tank and an engine and return lines. The improved connector structure facilitates quick assembly. The connector structure includes two parts, the smaller one acting as a lock for another connector which may be coupled to the connector structure. The new connector structure is constituted by a body which provides a housing for a lock, which has two movements. One movement permits the insertion of another connector into the connector structure, when it is pressed, and the subsequent locking in place of that connector after its insertion and a second opening movement, when one of its walls is pressed, which opens the lock and permits the removal of the other connector.

### PRIORITY CLAIM

This application claims the benefit under 35 USC 119 of the filing date of Brazilian Patent Application Serial No. PI0505733-7, filed Dec. 19, 2005, entitled “Compact Connector” which is incorporated herein by reference in its entirety.

### FIELD OF THE INVENTION

The present patent specification refers to a connector used in vehicle fluid lines, such as vehicle fuel lines, used between a fuel tank and an engine and a return line.

### BACKGROUND

Current vehicles require more and more smaller parts, due to reductions in available space and the increase in the number of components. On the other hand, in order to reduce costs, rapid assembly requires quick connectors which simultaneously provide a secure connection while assuring means to release a connecting structure coupled to it, when maintenance is required.

Several connectors are known, such as those disclosed in patents PI9600812, PI00034339, PI01018329, PI020254973, PI05009324, PI05009804, PI050520980 and PI05020999. These patents illustrate several connector configurations, which incorporate improvements which facilitate smaller connector constructions which in turn permit more rapid utilization.

### SUMMARY OF THE INVENTION

To improve connectors, the new connector structure permits quick assembly. The new connector structure is provided with two parts including a smaller part which acts as a locking arrangement for a further connector coupled to the connector structure. The new connector is constituted by a body provided with a housing for the lock, which facilitates two movements, one movement allowing the insertion of another connector when it is pressed, which assures a locking of the connector structure after the insertion of the other connector and a second opening movement, achieved when one of its walls is pressed, which facilitates the opening of the lock and the removal of the connector.

### DESCRIPTION OF THE DRAWINGS

Drawings attached illustrate new features for better understanding and comprehension:

FIG. 1: Corresponds to a perspective view of a Connector mounted with a self-retractable bracket.

FIG. 2: Represents a perspective view of a retaining ring.

FIG. 3: Illustrates a perspective view, of the connector structure wherein the upper portion of the connector structure has been partially removed revealing the retaining ring.

FIG. 4: shows a connector body view without a retaining ring.

FIG. 5: shows a side view of a duct with a ring that may be coupled to connector structure.

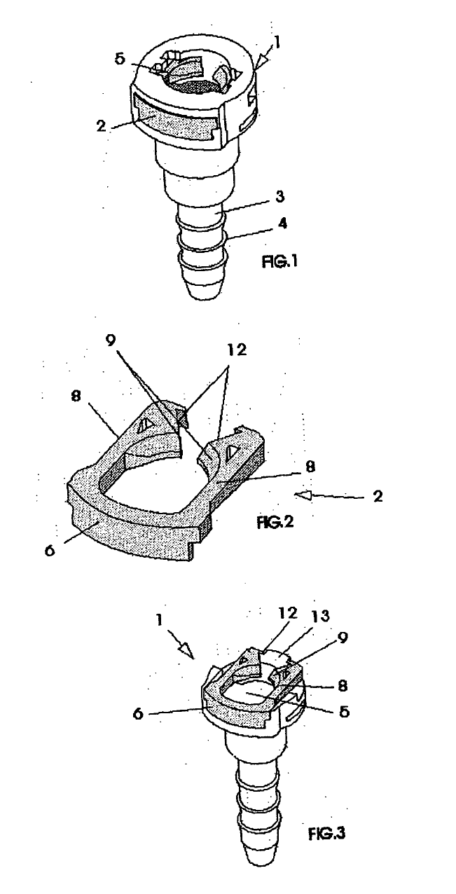

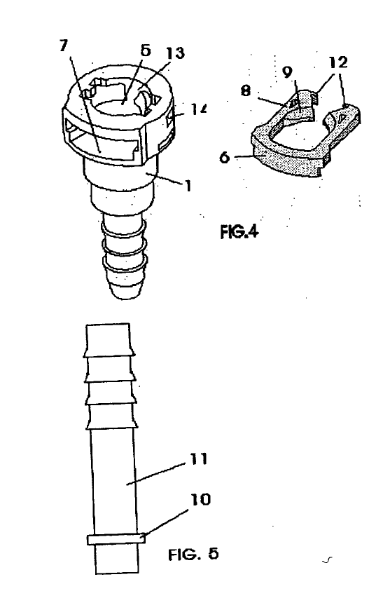

### DETAILED DESCRIPTION OF THE INVENTION

According to the attached drawings, which form part of this specification, a compact connector is constituted by a connector body (1), which receives a lock (2).

Connector body (1) is provided, on one hand with a cylindrical body (3) having scales (4), conceived to receive a hose; on the other hand, body (1) is provided with a housing (5) on its top for housing a “U”-shaped lock ring (2), having a face (6) positioned in a window (7) defined in housing (5) and also lock ring (2) has two arms (8), which define, on their interior surfaces, proximate their edges, two areas (9) having a descending slope on an upper region thereof and horizontal surfaces on the lower regions thereof, which function as a retainer of a ring (10) defined on a connector (11). The edges of arms (8) edges are provided with a “V”-shaped angle face (12), which acts as an angular side of front wall (13) of housing (5). Two windows (14) are provided in these sidewalls.

The connector structure (1) is actuated by inserting the connector (11) inside connector structure (1), in such a way that when ring (10) presses against the descending slopes of areas (9), arms (8) are opened, due to the presence of windows (14) which allows ring (10) to pass by lock (2) and to thereafter be retained by the projections defined by the descending slopes of the upper region of the areas (9). The lower regions of the areas (9), which are on the opposite side of the areas (9) from the descending slopes are straight and do not allow the removal of the connector (11).

To remove the connector (11) the face (6) of lock (2), which is visible through the window (7) of housing (5), must be pressed, thereby allowing the “V”-shaped faces (12) of arms (8) to slide on wall (13) which is provided with opposite angles, which then allows lock (2) to open and facilitates a removal of connector (11).

What is claimed is:

1. A compact connector constituted by a connector (1) provided, on one hand, with a cylindrical body (3) with scales (4) conceived to receive a hose and characterized by that body (1) being provided with a housing (5) on its top for a “U”-shaped lock (2), with a face positioned in a window (7) defined in housing (5) and also a ring (2), two arms (8), which define inside close to their edges, two areas (9) in descending slope by rear face and horizontal by lower one, while arms (8) edges are provided with a arms (8) “V”-shaped angle face (12), acting on front wall (13) provided with angles opposite to angle (12) of referred wall (13) of housing (5); this wall is provided with windows (14) on its sides.
